(19) United States
(12) Patent Application Publication
(10) Pub. No.: US 2002/0002627 A1
(43) Pub. Date: Jan. 3, 2002

(54) Method and system for interconnecting remote intelligent devices with a network

(76) Inventors: Graham Stead, Arlington, VA (US); Steven Jackson, Burke, VA (US)

Correspondence Address: Roberts Abokhair & Mardula, LLC, Suite 1000, 11800 Sunrise Valley Drive, Reston, VA, 20191, US

(21) Appl. No.: 09/885,668

(22) Filed: Jun. 20, 2001

Related U.S. Application Data
(60) Provisional application No. 60/212,570, filed on Jun. 20, 2000.

(51) Int. Cl. G06F 15/173; G06F 15/16

(52) U.S. Cl. 709/250; 709/238; 709/230

(57) ABSTRACT

A method and system for interconnecting intelligent devices (mobile or wired) with a remote network, while avoiding the need to use special remote applications loaded on the intelligent devices. This includes the use of proxy applications for remote controlling of items accessible via the remote network. The system includes a manager module and multiple tails modules. The manager provides for user access from a remote intelligent device to one or more tails. The tails either include clients for interfacing to a network or protocol, or the tails function as interfaces to commercially available clients for interfacing to a network or protocol.

### CROSS REFERENCE TO RELATED APPLICATIONS

This application claims priority under 35 U.S.C. §119(e) from provisional application no. 60/212,570, filed Jun. 20, 2000. The application 60/212,570 is incorporated herein by reference, in its entirety, for all purposes.

### INTRODUCTION

The present invention relates generally to a method and system for interconnecting remote intelligent devices with a network. More particularly, the present invention relates to a method and system for interconnecting remote intelligent devices, without using special remote applications, with a network, that includes Proxy applications, for remote control purposes.

### BACKGROUND OF THE INVENTION

There are two major technical fields that have shown explosive growth over the past few years: the first is wireless communications and the second is use of data services, particularly the Internet. These two technical fields both require special software and protocols in order to interconnect. Interestingly, wireless communications and data services are beginning to converge. Unfortunately, this convergence has not been accompanied by the development of appropriate techniques to allow simple interconnection between wireless remote intelligent devices and networks for remote control purposes.

The growth of wireless communications has been astounding. Twenty years ago, there was virtually no use of wireless communications devices such as cellular phones. In contrast, the market penetration for wireless devices in the U.S. in 1999 was 32 percent. The current forecast is that 80 percent of the U.S. population will be wireless subscribers by 2008.

The growth of data services has been just as astounding as the growth rate for the wireless industry. The largest driving force behind the growth of data services has been the enormous growth of the Internet. For example, there were 130 Web sites in June 1993, 230,000 Web sites in June of 1996, and 10 million Web sites at the end of 1999.

As previously mentioned, there is a tremendous convergence taking place that combines remote wireless intelligent devices with networks. Dataquest estimates that the U.S. wireless data market (including phones, PDAs, laptops, and the like) will grow from 3 million subscribers in 1999 to 36 million subscribers in 2003. Ericsson is estimating that 1 billion wireless units will be in use worldwide by 2003 and that 40 percent (400 million) of these units will be employed by data users. Furthermore, Ericsson is predicting that 2003 will be the crossover year in which wireless Web access will exceed wired Web access.

As a further measure of the explosive growth of the convergence of the wireless systems and the Internet, one can look at projections for the number of wireless portal subscribers. According to the Strategis Group, the number of wireless portal subscribers will increase from 300,000 in 2000, to 9.8 million in 2003, and finally to 24.8 million in 2006.

A variety of technical advancements have accelerated the convergence of Internet access over wireless devices. In 1997, three competing handset vendors (Nokia, Ericsson, and Motorola) and a small software company (Openwave, formerly Phone.com, previously known as Unwired Planet) joined forces to create a standard way to transmit Internet data to wireless phones without occupying too much bandwidth. The result of this collaboration was development of the wireless application protocol (WAP). One basic component of WAP was development of the WML (Wireless Markup Language, replacing the previous Phone.com Handheld Device Markup Language, HDML) that compresses Web content in comparison to HTML. Additionally, the WAP forum developed standards for the use of microbrowsers in mobile devices.

It is important to note that the term WAP is being used generically to refer to any wireless Internet protocol, including HDML and any future wireless Internet protocols that may be developed. The following examples are provided of some competing technologies that for the purposes of this patent will be referred to generically as WAP. For example, the Web content can be delivered as text messaging or as an SMS message (as proposed by Xypoint or GOSMS) so that it is compatible with existing cellular phones. Alternatively, the Web content can be delivered as existing HTML Internet content for wireless devices as proposed by Spyglass' Prism technology or Japan's iMode. As a further example, the content can be processed through a template model that reads existing HTML content and fits the data to a template optimized for various types of wireless phones such as the system proposed by Everypath.com. As another example, the data content can be delivered to a Palm Pilot or other PDA or handheld device that uses a proprietary protocol.

FIGS. 1-6 show a variety of products that have been proposed or introduced to provide some degree of connectivity between wireless devices and networks.

Referring to FIG. 1, a typical home automation system is illustrated, such as those developed by Nokia-KFN, ONQ Technologies, Siemens, Multisens, and Integrated Media Installations, just to name a few manufacturers. In FIG. 1, a Wireless Handset 10 is connected to a Wireless Handset Interface 20, such as a wireless network WAP Gateway, via a wireless communication link. The Wireless Handset Interface 20 is connected to a WAP Server 30 via a WAP Server communication link, such as the Internet. The WAP server 30 is connected to a Home Router 40 via the Internet 50. Finally, the Home Router is connected to a plurality of Home Sensor/Controls 1 through N (42) via a home communication link, such as X10 or Bluetooth.

A home automation system allows the user to control and access home devices using a wireless handset. The home devices that can be controlled include items such as heat, lighting, and ventilation. The home devices that can be accessed include the state of a burglar alarm or the time your spouse entered the house, for example. A typical scenario for use of the home automation system involves the user using a WAP-enabled handset to dial home from the car and switch on the heating system and lights prior to arrival. One of the problems with home automation systems is that they do not provide a general-purpose method for accessing a variety of network types from the wireless handset. They are limited to special purpose Home Sensor/Controls connected by a special purpose Home Router.

Referring to FIG. 2, a special Distributed Device Network (DDN) is illustrated, such as the emWare system used in conjunction with Oracle. The DDN includes a Wireless Handset 10 connected to a Wireless Handset Interface 20, such as a wireless network WAP Gateway, via a wireless communication link. The Wireless Handset Interface 20 is connected to a WAP Server 30 via a WAP Server communication link, such as the Internet. The WAP server 30 is connected to an emGateway 60 via a Data Network or the Internet 70. The emGateway 60 is connected to a plurality of emRouters 80 via gateway communication links, such as a Data Network or the Internet. Each of the emRouters 80 is connected via a router communication link, such as a Data Network or the Internet or a lightweight RS-485 network, to a respective plurality of emMicro Devices 90.

The emMicro devices 90 can be based on 8, 16, or 32 bit processors commonly found in a variety of home and business products. The emMicro devices use a special protocol stack (which takes minimal program space and minimal processing power) to allow management and remote control of the emMicro device without the need for a Realtime Operating System (RTOS) or TCP/IP stack. The emGateway and emRouters provide a method for interfacing the emMicro devices to a standard network such as a TCP/IP network. Similarly to the home automation system, one of the problems with the DDN networks is that they do not provide a general-purpose method for accessing a variety of network types from the wireless handset. They are limited to special purpose emMicro Devices.

Referring to FIG. 3, a typical Remote Access System (RAS) or Virtual Private Network (VPN) is illustrated, such as a Pocket PC with PC Anywhere CE, a Palm PDA with Palm VNC v1.1, or a laptop with Check Point's VPN Software. The mobile terminating device for the RAS or VPN is either a PDA 110 or a laptop 120, but not a wireless handset. The PDA 110 or laptop 120 is connected via a wireless communication link to a wireless interface 130, such as the Palm PDA gateway or a CDPD server. The wireless interface is connected via a Data Network or the Internet 70 to a local machine 140, such as a local server, a local PC, or more generally a corporate LAN. The RAS and VPN products allow remote connection of either the PDA 110 or the laptop 120 to the local machine 140. In fact, the RAS products generally provide an interface at the remote device that looks like the interface at the local device (except for the smaller screen size of the remote device). One of the problems with the RAS and VPN products is that they require the remote device, either the PDA or the laptop, to run special software in order to connect to the network. This greatly limits the number of remote devices that can use these products.

Referring to FIG. 4, a typical middleware product is illustrated, such as IBM MQSeries Everyplace or Vast Volley. Middleware provides a mobile terminating device with the ability to interconnect with a specially configured server. A mobile terminating device, such as a wireless handset 10 or PDA 110 or laptop 120, is connected via a wireless communication link to a wireless interface 150. The wireless interface 150 is connected via the Internet or a data network 70 to a local server 160 with special application software. One of the problems with the middleware products is that they require the installation of special software at the target network so that they do not provide a general-purpose method for accessing a variety of network types from the mobile terminating device.

Referring to FIG. 5, a typical JINI network is illustrated, in which devices connect over a bus independently of the network type. The JINI network includes a plurality of JINI devices 170 (1 through N) and a JINI look-up device 180 that are connected via a bus 190. A new JINI device 170 connects to the network through a two-step process. Step one is a discovery process in which the new JINI device 170 polls the network to locate a JINI lookup device 180. Step two is a join process in which the new JINI device 170 registers itself with the JINI lookup device 180 by registering itself including the device type and a device driver. Other JINI devices will check with the JINI look-up device to see what devices are on the network, and download the appropriate driver if they need to communicate with a particular JINI device. One of the problems with the JINI method is that it requires the remote device to run the JINI protocol that limits the number of remote devices that can use this method.

Referring to FIG. 6, a typical network is illustrated, in which wireless devices receive push data from a local machine or a server, such as a PC running Roku for e-mail notification. A wireless handset 10 is connected via a wireless communications network to a wireless interface 130, such as a wireless network WAP gateway or an SMS IWF. The wireless interface is connected via the Internet or a Data Network 70 to a local machine or a server 196. There are a variety of wireless portals and corporate vertical applications for pushing data to wireless devices such as Infospace, Weather.com, Yahoo.com, Mapquest.com, ThinAirApps, Visto.com, E-Link, InfoWave, SmartRay, III, Strategy.com, BlackBerry, and Bulletin. One of the problems with the push data products is that they do not allow for general-purpose connections to networks from the wireless handset 10.

Unfortunately, the development of wireless Web access technology has significantly outpaced the development of a simple general-purpose solution to interconnect with a network. Accordingly, there is a tremendous need for a solution to provide a method and system for this type of interconnection.

### SUMMARY OF THE INVENTION

In order to meet need identified above, a method and system is provided for interconnecting remote intelligent devices with a network.

The present invention provides for a method and system for interconnecting remote intelligent devices, without using special remote applications, with a network, that includes Proxy applications, for remote control purposes.

According to one embodiment of the invention, the system provides for a Wireless or Wired Interconnection Proxy Involving Tails (referred to by the trade name “WIPIT”). The system includes a Manager and multiple Tails. The Manager provides for user access from a remote intelligent device to a Tail or Tails. The Tails are either clients for interfacing to a network or protocol, or the Tails are interfaces to commercially available clients, that already exist, for interfacing to a network or protocol.

Either the Manager or the Tails can include a Proxy so that a process can be started by the remote intelligent device and continue running even after the remote intelligent device disconnects from the network. Furthermore, the remote intelligent device can be used for remote control of operations on the network by selectively activating a Tail for the desired action. Since the client functionality is handled by the Tail, the remote intelligent device does not need to run any special application software. This feature allows the present invention to interoperate with a broad range of existing remote intelligent devices, such as wireless handsets, PDAs, 2 way data devices, laptops, etc.

Furthermore, a well-defined Application Programming Interface (API) is provided between the Manager and the Tail so that 3^{rd} party developers can develop tails for specific protocols, networks, and operations.

Accordingly, an object of the present invention is to provide a method and system for interconnecting remote intelligent devices, without using special remote applications, with a network, that includes Proxy applications, for at least remote control purposes.

A further object of the invention is to provide a Manager for user access from a remote intelligent device to a Tail or Tails. The Manager can provide user authentication for security purposes and maintain user profiles and user states.

Another object of the invention is to provide Tails, that interconnect with the Manager through a well-defined API, the Tails are either clients for interfacing to a network or protocol, or the Tails are interfaces to commercially available clients, which already exist, for interfacing to a network or protocol.

A further object of the invention is to provide proxy functionality in either the Manager or the Tails so that a process can be started by the remote intelligent device and continue running even after the remote intelligent device disconnects from the network.

Another object of the invention is to provide Tails that can connect to a data network, connect to database, connect to an application, exist as an application, provide an extension to the Manager for additional add-on services (e.g., additional security), connect to special networks (e.g., device networks, JINI, etc.), and provide an alternate user interface point to the Manager.

A further object of the invention is to allow tails to communicate with each other and perform functions in unison.

Another object of the invention is to provide for both wired and wireless remote intelligent devices. For example, the wireless remote intelligent devices can include wireless handsets, PDAs, 2 way data devices, and laptops.

Advantages of the current invention include the ability to allow a wide degree of interconnection between standard remote intelligent devices (with no modifications or special application software) and standard networks, databases, or applications.

Additional objects and advantages of the present invention will be apparent in the following detailed description read in conjunction with the accompanying drawing figures.

### BRIEF DESCRIPTION OF THE DRAWINGS

FIG. 1 illustrates a typical home automation system.

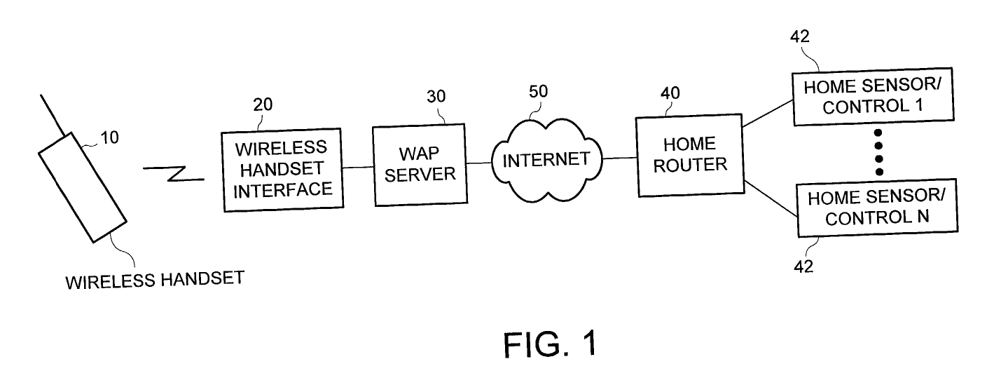

FIG. 2 illustrates a special Distributed Device Network (DDN).

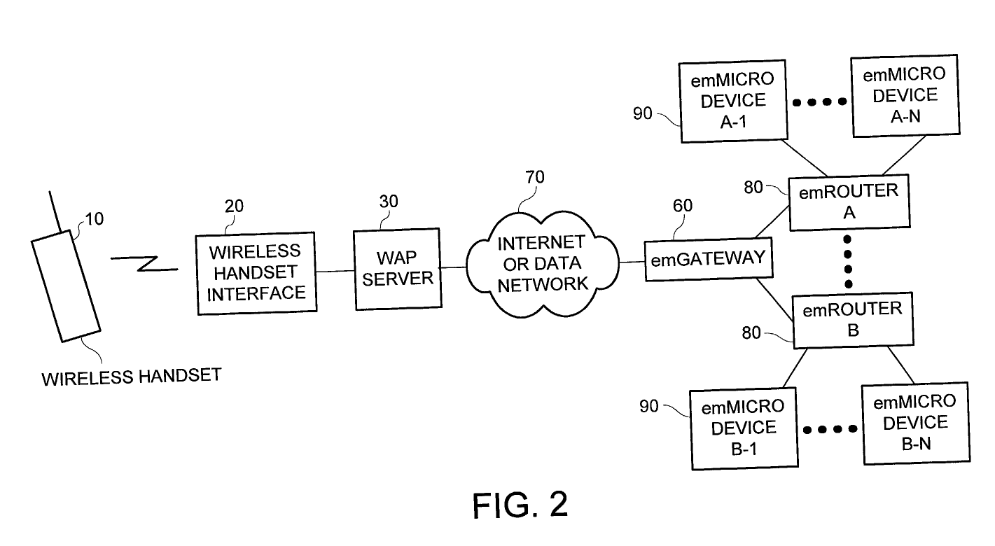

FIG. 3 illustrates a typical Remote Access System (RAS) or Virtual Private Network (VPN).

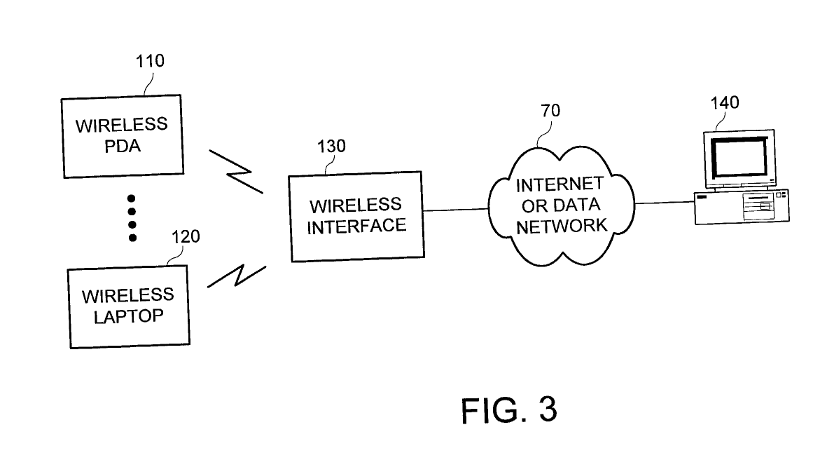

FIG. 4 illustrates a typical middleware product.

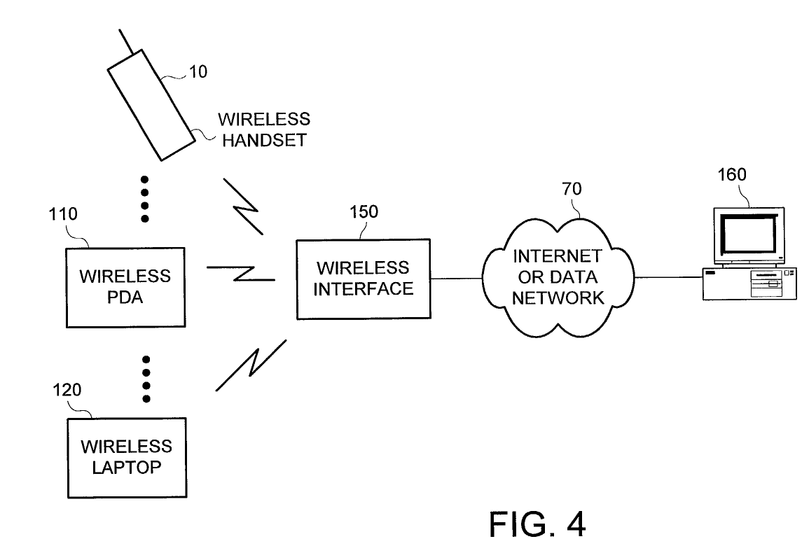

FIG. 5 illustrates a typical JINI network in which devices connect over a bus independently of the network type.

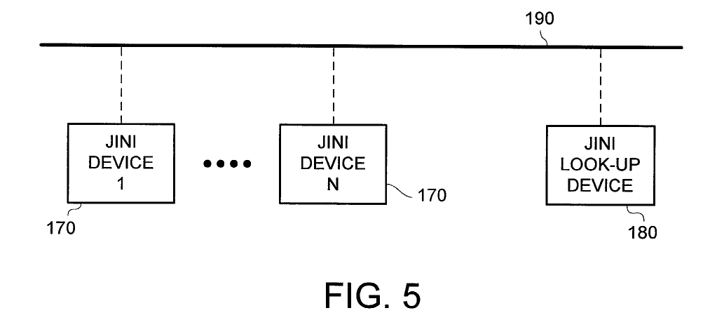

FIG. 6 illustrates a typical network in which wireless devices receive push data from a local machine or a server, for example for e-mail notification.

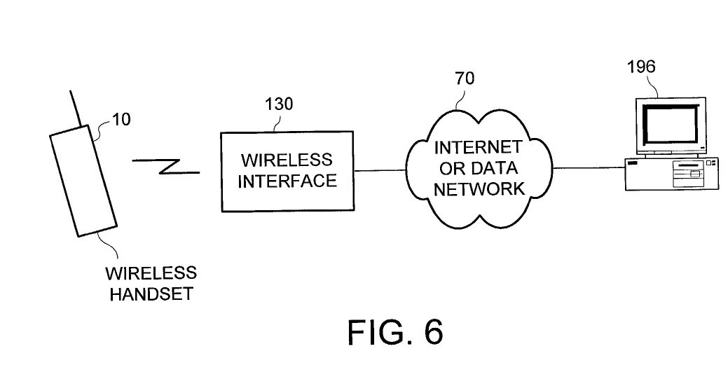

FIG. 7A illustrates a basic system architecture, in accordance with one embodiment of the present invention.

FIG. 7B illustrates a system architecture including various wireless and wired remote intelligent devices, in accordance with a further embodiment of the present invention.

FIG. 7C illustrates a system architecture including various Tails, consistent with various embodiments of the present invention.

FIG. 8 illustrates a typical system architecture including various wireless remote intelligent devices and Tails connected to Data Networks, in accordance with another embodiment of the invention.

FIG. 9 illustrates a typical system architecture including various wireless remote intelligent devices and Tails connected to Data Networks, along with a separate notification interface, in accordance with another embodiment of the invention.

FIG. 10 illustrates a method for interconnecting remote intelligent devices with a network, in accordance with an embodiment of the invention.

### DETAILED DESCRIPTION

I. System for Interconnecting

The present invention provides for a method and system for interconnecting remote intelligent devices, without using special remote applications, with a network, that includes Proxy applications, for remote control purposes.

According to one embodiment of the invention a system is provided for interconnecting an intelligent device with a remote element. The system has a manager module and a tail module. The manager module is adapted for communication with the intelligent device. The tail module is interfaced with the manager module according to an application program interface, and interfaced to the remote element. The manager module and the tail module provide interconnection of the intelligent device to the remote element when the intelligent device is in communication with the manager module. For purposes of this disclosure, a remote element is regarded as including a network, a database, or a special application, just to list a few examples. The special application may be implemented separately from the tail or may be implemented as a part of the tail.

According to another embodiment of the invention, the system provides for a Wireless or Wired Interconnection Proxy Involving Tails (referred to by the trade name “WIPIT”). The system includes a Manager and multiple Tails. The Manager provides for user access from a remote intelligent device to a Tail or Tails. The Tails are either clients for interfacing to a network or protocol, or the Tails are interfaces to commercially available clients, that already exist, for interfacing to a network or protocol.

Either the Manager or the Tails can include a Proxy so that a process can be started by the remote intelligent device and continue running even after the remote intelligent device disconnects from the network. Furthermore, the remote intelligent device can be used for remote control of operations on the network by selectively activating a Tail for the desired action. Since the client functionality is handled by the Tail, the remote intelligent device does not need to run any special application software. This feature allows the present invention to interoperate with a broad range of existing remote intelligent devices, such as wireless handsets, PDAs, 2 way data devices, laptops, etc. For the purposes of this disclosure, we regard a remote intelligent device as being any device that has both a processing functionality and a communication functionality.

The remote control can allow a wide variety of functions on the network just by using the Remote Intelligent Device, such as a Wireless Handset. For example, the remote control can be used to remotely search for a file on the corporate LAN, attach the file to an e-mail, and then send the e-mail to your home computer or to a colleague. As another example, the user can remotely search for a file on the corporate LAN and fax or print the document to the home fax machine/printer or a colleague's fax machine/printer. As a further example, a user can search for a file using Gnutella, and then store the file on an I-drive. These are just a few illustrative examples and in no way limit the broad applicability of the invention.

Furthermore, a well-defined Application Programming Interface (API) is provided between the Manager and the Tail so that third party developers can develop tails for specific protocols, networks, and operations.

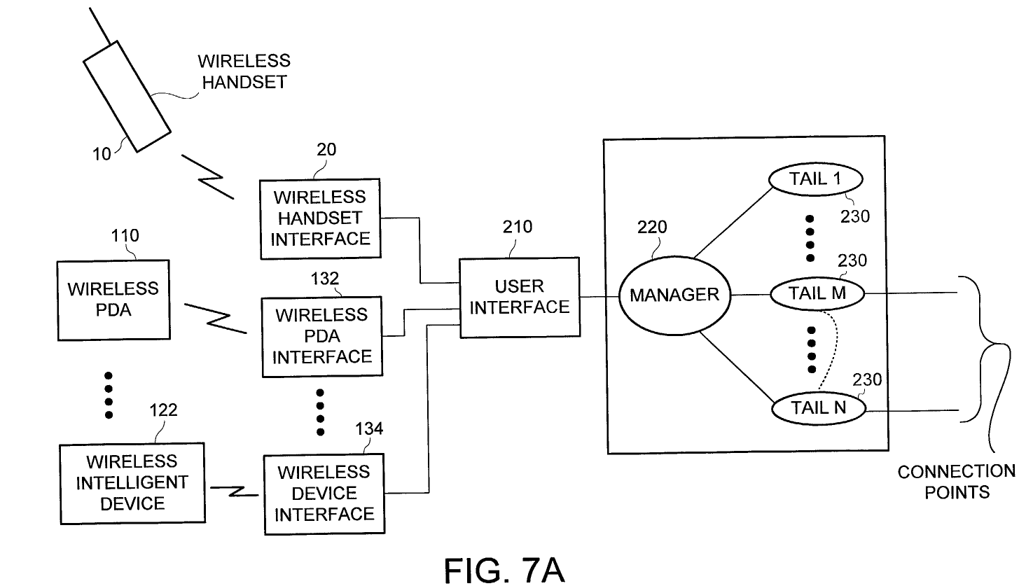

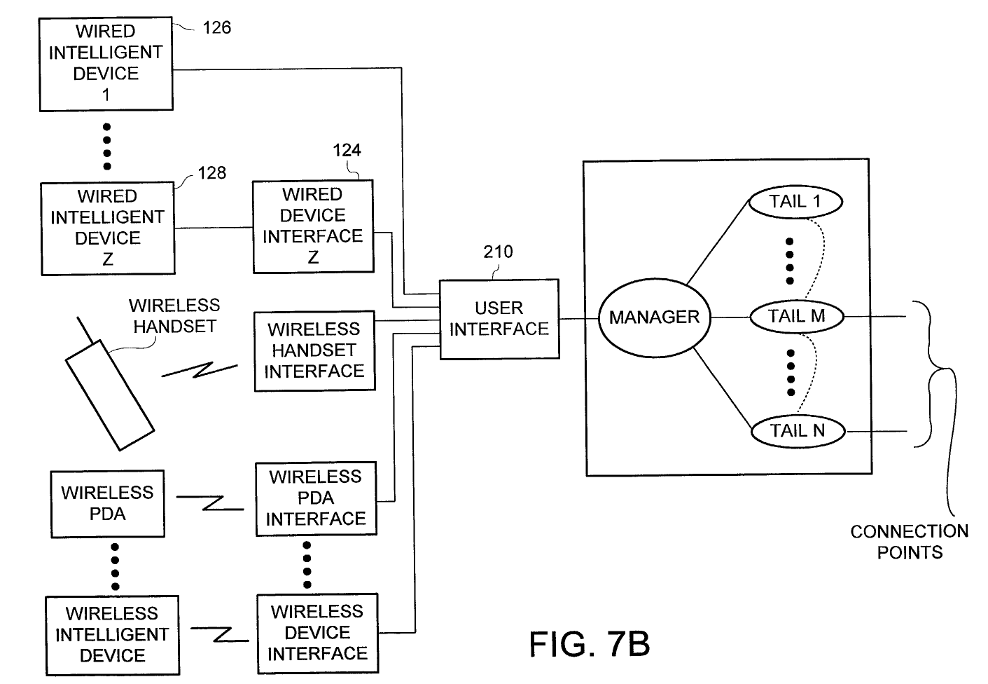

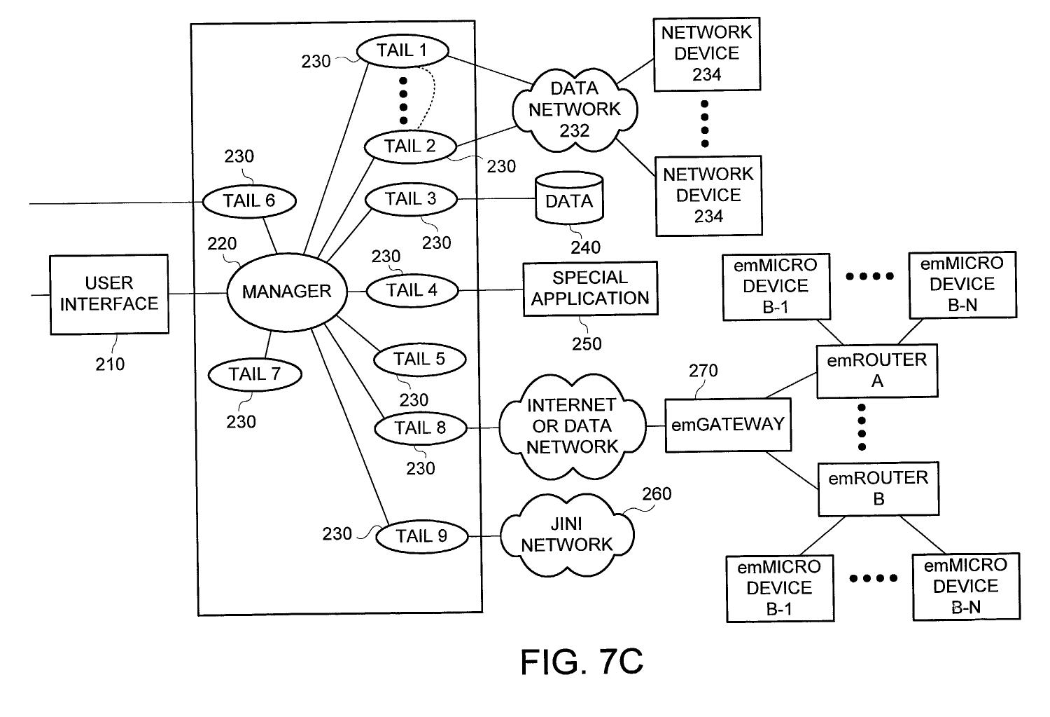

FIGS. 7A-7C, 8, and 9 illustrate the system architecture in accordance with various embodiments of the invention.

Referring specifically to FIG. 7A, a basic system architecture, in accordance with one embodiment of the invention, is illustrated. The system includes a variety of Wireless Intelligent Devices including a Wireless Handset 10 and a PDA 110. The Wireless Handset 10 is connected via a first wireless communication link to a Wireless Handset Interface 20, such as a wireless network's WAP gateway. The PDA 110 is connected via a second wireless communication link to a Wireless PDA Interface 132, such as the Palm Server or a CDPD server. The generic Wireless Intelligent Device 122 is connected via a third communication link to a Wireless Device Interface 134. The Wireless Handset Interface 20, Wireless PDA Interface 132, and Wireless Device Interface 134 are connected via first, second, and third communication links, respectively, to a User Interface 210. The first, second, and third communication links can be implemented as a data network (public or private), the Internet, or a direct communication connection (e.g., T1, DSL, or RS-232).

The User Interface 210 can be implemented as Web Server such as a WAP server or an HTML server. By using a Web Server, the system is able to use a standard Wireless Intelligent Device without any special application software, and provide the interface software as an ASP or CGI at the Web Server. The User Interface 210 is connected to the Manager 220 via a user interface communication link, such as a data network (public or private), the Internet, or a direct communication connection (e.g., T1, DSL, or RS-232). The user communication link is not required in systems in which the User Interface 210 and Manager 220 are located on the same machine. The API for the front-end of the Manager 220 is a standard communication interface, such as a socket or DDE for example.

The Manager 220 can provide user authentication for security purposes and maintain user profiles and user states. Most importantly, the Manager 220 provides a common interface or API to a plurality of Tails 230. The Manager 220 is connected to each of the Tails 230 (1-N) via a respective Manager communication link. The Manager communication link can be implemented as a data network (public or private), the Internet, or a direct communication connection (e.g., T1, DSL, or RS-232). The Manager communication link is not required in systems in which the Manager 220 and Tail 230 are located on the same machine.

The Tails 230 can either be the terminating point for the operation as shown by Tail 1, or provide interconnection to further connection points such as those shown for Tails M and N. In addition, Tails 230 may have the capability of communicating with each other via an optional Tail communication link (shown as a broken line) between Tail M and Tail N. The possible connection points and Tail applications will be discussed further in relation to FIG. 7C.

Referring to FIG. 7B, a system architecture, including various wireless and wired remote intelligent devices, in accordance with a further embodiment of the invention, is illustrated. FIG. 7B includes all of the elements and connections discussed with relation to FIG. 7A. In addition, FIG. 7B includes Wired Intelligent Devices 126, 128 (1 through Z). The Wired Intelligent Devices 126, 128 can be connected to the User Interface 210 through a direct wired link as shown for Wired Intelligent Device 1 (126), or through Wired Device Interface Z (124) as shown for Wired Intelligent Device Z (128).

Wired Intelligent Device 1 (126) can be a remote computer connected to the User Interface 210 through a data network (public or private), the Internet, or a direct communication connection (e.g., T1, DSL, or RS-232). In contrast, Wired Intelligent Device Z (128) represents a device that needs some form of translation such as the emMicro devices discussed previously. Since the User Interface is implemented in a standard manner, for example using a Web Server, the Wired Intelligent Devices 1-Z (126, 128) simply need to run a standard Web Browser so that no special application software is required.

Referring to FIG. 7C, a system architecture is illustrated, including various Tails, in accordance with another embodiment of the invention. As previously discussed, the User Interface 210 is connected to the Manager 220 via a user communication link. The Manager 220 is further connected to Tails 230 via respective Manager communication link. The Manager communication link can be implemented as a data network (public or private), the Internet, or a direct communication connection (e.g.,T1, DSL, or RS-232). The Manager communication link is not required in systems in which the Manager and Tail are located on the same machine.

The Tails 230 may have various optional functionalities, described as follows. Tail 1 and Tail 2 are connected to Network Devices 234 through Data Network 232. In addition, Tail 1 and Tail 2 are connected to each other through an optional Tail communication link. The Data Network 232 may be a corporate LAN, a public or private data network, or the Internet, for example. The Tails 230 may implement a variety of network clients such as the File Explorer included in the MS Windows OS, Gnutella, ICQ Instant Messaging, Jabber, or an e-mail client.

Tail 3 is connected to a database 240. Tail 3 allows the user to connect from the Remote Intelligent Device to the database 240 using a customized client. For example, a corporation could allow a mobile workforce the ability to remotely complete timesheets and log their hours in the company's accounting database, for example.

Tail 4 is a client that is interfaced with a custom application 250. Tail 5 is similar to Tail 4, but the special application is included in the Tail itself.

Tail 6 provides an alternative user interface for cases in which the Remote Intelligent Device cannot connect through the User Interface 210. For example, this could occur in a case in which the Remote Intelligent Device did not include a Web Browser but the User Interface was implemented as a Web Browser. Tail 6 adds further possibilities in that the connection does not even need to be established by a Remote Intelligent Device, the connection can be established with another process. For example, Tail 6 could be connected with another Tail on a different company's system.

Tail 7 is used to provide an extension to the standard Manager 220 for additional services, for example additional security.

Tail 8 is used to connect to additional networks with very simple devices such as the emMicro network 270 discussed above. Likewise, Tail 9 is used to connect to additional networks with very simple devices such as the JINI network 260 discussed above. In fact, the system in accordance with the invention is useful to interconnect with any type of network as long as the network protocol is known in order to write the Tail program. Since the API between the Tail and the Manager is open, it is anticipated that third party developers will develop Tails for interconnecting with a variety of networks.

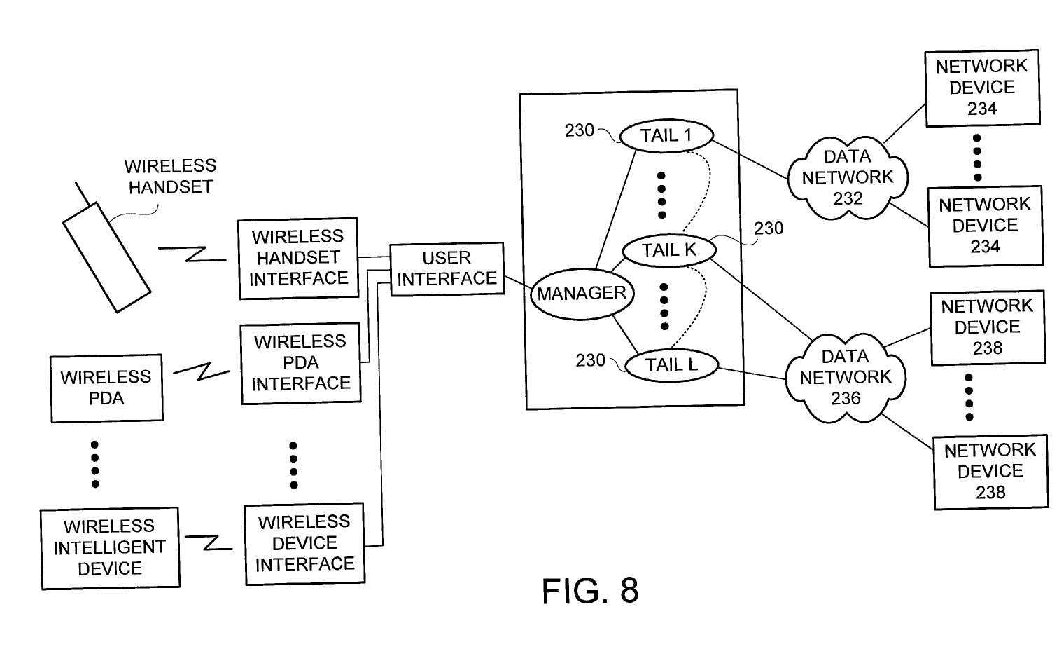

Referring to FIG. 8, a typical system architecture is illustrated, including various wireless remote intelligent devices and Tails connected to Data Networks, in accordance with another embodiment of the invention. FIG. 8 includes the same elements and connections as described with regard to FIG. 7A. In addition, FIG. 8 includes Tail 1 connected to Network Devices 234 through Data Network 232. Also, Tail 1 and Tail K are connected to each other through an optional Tail communication link. The Data Network 232 can be a corporate LAN, a public or private data network, or the Internet, for example. The Tails 230 can implement a variety of network clients such as the File Explorer included in the MS Windows OS, Gnutella, ICQ Instant Messaging, Jabber, or an e-mail client.

Furthermore, the Tails 230 allow the creation of virtual user groups which link a selected group of people together from different networks. For example, if a group of people from different companies is working an a special project, the Manager and/or Tail can be configured with a list of the users and the files along with privileges so that a virtual LAN has been created through the invention.

Likewise, Tails K and L are connected to Network Devices 238 through Data Network 236. In addition, Tail K and Tail L are connected to each other through an optional Tail communication link. The Data Network 236 can be a corporate LAN, a public or private data network, or the Internet, for example. The Tails 230 can implement a variety of network clients such as the File Explorer included in the MS Windows OS, Gnutella, ICQ Instant Messaging, Jabber, or an e-mail client.

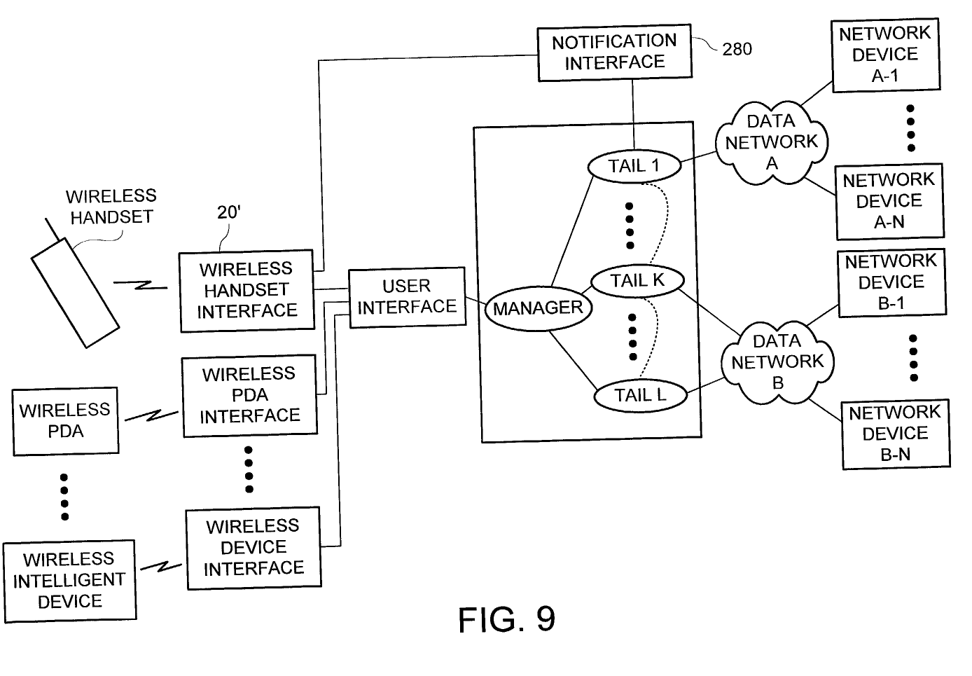

Referring to FIG. 9, a typical system architecture is illustrated, including various wireless Remote Intelligent Devices and Tails connected to Data Networks, along with a separate notification interface, in accordance with another embodiment of the invention. FIG. 9 includes the same elements and connections as described with regard to FIG. 8. In addition, FIG. 9 includes a Notification Interface 280 located between Tail 1 and the Wireless Handset Interface 20′. The Notification Interface allows for a path different than the remote control path for provision for notification. For example, a user may start a Gnutella search and request an SMS notification when the correct file is located. This takes advantage of the Proxy nature of the system by allowing notifications to be generated and sent through different paths when the operation is completed or status information needs to be reported.

II. Method for Interconnecting

Another embodiment of the present invention provides a method for interconnecting an intelligent device with a remote element. The method includes a step of providing a manager module adapted for communication with the intelligent device. The method also includes a step of interfacing a tail module with the manager module according to an application program interface. Additionally, the method includes the step of interfacing the tail module with the remote element. An interconnection of the intelligent device to the remote element is provided via the manager module and the tail module when the intelligent device is in communication with the manager module. In the event that the intelligent device is no longer in communication with the manager module, a connection to the network may be maintained on behalf of the intelligent device via a proxy application in the manager module (or in the tail module).

In accordance with a further embodiment of the invention, a method is provided for interconnecting remote intelligent devices, without using special remote applications, with a network, that includes Proxy applications, for remote control purposes.

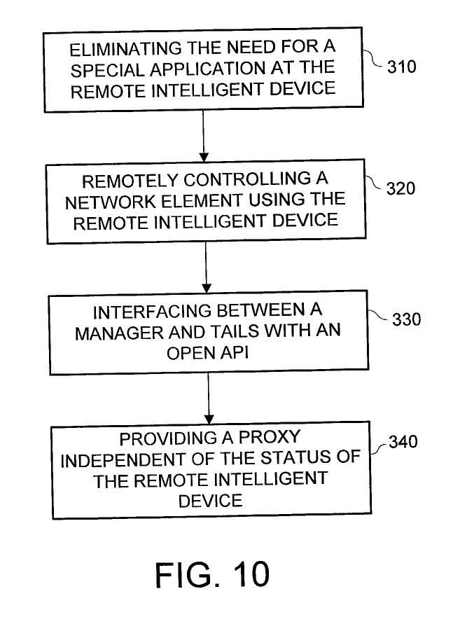

Referring to FIG. 10, a method is illustrated for interconnecting remote intelligent devices with a network, in accordance with an embodiment of the invention.

The method includes a step 310 of eliminating the need for a special application at the remote device. This step is advantageous because it increases the number of remote intelligent devices that can use the method in accordance with the invention.

Another step 320 of the method is remotely controlling a network element using the remote intelligent device. It is important to note that the remote control feature does not preclude the delivery of data to the remote intelligent device, it merely adds an additional capability that is different than the capability of many of the existing products which concentrate on the Remote Intelligent Device as the termination device for data delivery. For example, a user may use a Tail which functions as a File Explorer client to find a file and then use another Tail that functions as a mail client to send the file as an e-mail attachment. If the user is using a Pocket PC, the e-mail can be sent either to another machine or directly to the Pocket PC itself. In this example, the Pocket PC acts as both a remote control and as the terminating device for the data.

A further step 330 of the method is interfacing between a Manager and Tails with an open API. The advantage of an open API is that it encourages 3^{rd} party developers to develop Tails in accordance with the method.

Another step 340 of the method is providing a Proxy, independent of the status of the Remote Intelligent Device, at the Manager and the Tails. The advantage of the Proxy is that it allows the Tails to work somewhat autonomously of the Remote Intelligent Device. Once a remote control is sent from the Remote Intelligent Device to the Tail, the Remote Intelligent Device can disconnect from the network while the Tail carries out the function. This is particularly useful in an environment in which the Remote Intelligent Device is a wireless device, such as a wireless handset, which frequently connects and disconnects from the network.

III. Operational and Business Model

The previous sections of this description have discussed a method and system for interconnecting remote intelligent devices, without using special remote applications, with a network, that includes Proxy applications, for remote control purposes. In light of those previous sections, the following section discloses the operational and business model for the system in accordance with a further embodiment of the invention.

There are at least three possible business objectives for the WIPIT business model: to make money, to generate publicity, and to provide a connection with other products.

The system has three aspects of substantial interest from a business standpoint: the Manager, the Tails, and the API. The interface between the Manager and the Tails would advantageously be published as an open API. This would permit developers to develop Tails to perform specific functions such as implementing a client for certain protocols, e.g. file explorer or Gnutella. It is possible that these Tails may be freely provided to users in order to encourage user acceptance and use of the system.

There are a variety of possible business models for the Tails. As previously mentioned, some Tails may be available for free (probably as open source code). Some of these Tails will be developed by a proponent of the system to encourage initial use of the system. Furthermore, because of the open API additional Tails may be developed by third party developers and freely distributed, for example over the Internet. Some developers may post their Tails as shareware, rather than freeware, in which they will ask for a small fee from users who use the Tail.

Some Tails will be developed as proprietary Tails for internal use only by a closed group of users (e.g., users in a corporation or governmental unit) and not distributed to other users. For example, a company may develop a Tail that interfaces to a timesheet database to allow the entry of timesheet information for traveling workers.

In addition, a proponent of the system or other third parties may develop commercial Tails for useful tasks. These Tails can be licensed for use, perhaps sold outright, or operated as an ASP for use on an as-needed basis.

One example is seen in an MP3 service that stores and distributes MP3 audio files to interested listeners. For example, the user may hear a new song on his car radio, locate the song on the MP3 server using the WAP browser on his wireless handset, and download the MP3 file as an attachment to an e-mail that is sent to his home computer (which will be sitting on his home computer when he arrives home). The MP3 files could be distributed freely or based on a fee which could be pre-paid, added to the phone bill, billed monthly as part of the MP3 service fee, etc.

Such an electronic commerce method involves a number of steps. The method includes causing the intelligent device to be in communication with a manager module adapted for communication with the intelligent device. The method also includes establishing interconnection of the intelligent device to the network via the manager module interfaced with a tail module according to an application program interface, the tail module being interfaced with the network. Communication is also established between the intelligent device and a server connected to the network. An item is identified on the server using the intelligent device, which is in communication with the server. Fulfillment of the item to a destination is requested, via the network, in exchange for consideration.

Another example of a commercial Tail is an application that is developed to work with a particular piece of hardware. For example, if a manufacturer has developed devices for extracting biometric data such as retinal scans, thumb prints, etc., the Tail can be developed to receive this data from remote devices, compare it with a central database, and provide a GO or NO-GO indication based on the comparison result. The system operator could then enter in to an arrangement with the hardware developer to jointly market the hardware and the custom Tail in order to improve user acceptance of the new hardware product.

There are several business models available for the Manager including: providing it free and open source, free and closed source, or not free and closed source. The advantage of offering the Manager free and open source is that this will greatly accelerate the acceptance of the system. Users will have no financial barrier to use and will feel comfortable because the open source code will be improved and analyzed by other users. If the Manager is provided free, but not as open source code, the level of comfort may not be as high but the cost barrier will still be eliminated.

If the Manager is provided under the not free and not open source model, there are a variety of models for generating revenues. The Manager can be sold, operated as an ASP, or licensed for use as previously described in relation to the Tails.

In addition to the above business models, the system operator can generate additional revenue through a variety of additional services, including but not limited to: providing service/consulting for use of the system, providing paid support for users, developing custom Tails for special applications, and providing a standard easy to install and configure system package. The system package option is similar to the approach taken by Red Hat in relation to Linux in which free and open source software is provided in an integrated package to increase customer satisfaction with the ease of use.

In a further embodiment, the invention can be provided as a value added service in conjunction with a wireless user network presence system such as the system described in patent application Ser. No. 09/771,201, filed on Jan. 26, 2001 by Mark McDowell et al. and entitled “Method and Apparatus for Sharing Mobile User Event Information Between Wireless Networks and Fixed IP Networks,” as well as patent application Ser. No. 09/810,114 filed on Mar. 16, 2001 by Mark McDowell et al. and entitled “Use of Presence & Location Information Concerning Wireless Subscribers for Instant Messaging & Mobile Commerce.”

The present invention has been described in terms of preferred embodiments, however, it will be appreciated that various modifications and improvements may be made to the described embodiments without departing from the scope of the invention.

What is claimed is:

1. A system for interconnecting an intelligent device with a remote element, the system comprising:
a manager module adapted for communication with the intelligent device; and
at least one tail module interfaced with the manager module according to an application program interface, and interfaced to the remote element;
wherein the manager module and the tail module provide interconnection of the intelligent device to the remote element when the intelligent device is in communication with the manager module.

2. The system for interconnecting of claim 1, wherein the manager module comprises a proxy application that maintains a connection to the remote element on behalf of the intelligent device in the event that the intelligent device is no longer in communication with the manager module.

3. The system for interconnecting of claim 1, wherein the tail module comprises a proxy application that maintains a connection to the remote element on behalf of the intelligent device in the event that the intelligent device is no longer in communication with the manager module.

4. The system for interconnecting of claim 1, wherein the intelligent device is interconnected to the remote element without using an application in the intelligent device to interface the intelligent device to a communications protocol of the remote network.

5. The system for interconnecting of claim 1, wherein the tail module comprises a client that interfaces to the remote element.

6. The system for interconnecting of claim 1, wherein only a single tail module is utilized to effect interconnection of the intelligent device to the remote element.

7. The system for interconnecting of claim 1, wherein plural tail modules are utilized to effect interconnection of the intelligent device to the remote element.

8. The system for interconnecting of claim 1, wherein a first one of the at least one tail modules is utilized to effect interconnection of the intelligent device to the remote element, and wherein a second one of the at least one tail modules is utilized to effect interconnection of the intelligent device to a second remote element.

9. The system for interconnecting of claim 1, wherein the tail module is utilized to effect interconnection of the intelligent device to the remote element, as well as a second remote element.

10. The system for interconnecting of claim 1, wherein the remote element comprises a network.

11. The system for interconnecting of claim 1, wherein the manager module is adapted for communication with the intelligent device via a network.

12. The system for interconnecting of claim 11, wherein the manager module is adapted for communication with the intelligent device via a wired network.

13. The system for interconnecting of claim 1, wherein the remote element comprises a database.

14. The system for interconnecting of claim 1, wherein the remote element comprises a special application

15. The system for interconnecting of claim 1, wherein the manager module is configured with a list of users, a list of files, and privilege designation so as to establish a virtual local area network.

16. The system for interconnecting of claim 1, wherein the at least one tail module is configured with a list of users, a list of files, and privilege designation so as to establish a virtual local area network.

17. The system for interconnecting of claim 1, the system further comprising:
a notification interface connected to the tail so as to provide for transmission of a notification from the tail to the intelligent device.

18. The system for interconnecting of claim 1, wherein the tail module establishes a communication link with another tail module.

19. A method for interconnecting an intelligent device with a remote element, the method comprising:
providing a manager module adapted for communication with the intelligent device;
interfacing at least one tail module with the manager module according to an application program interface; and
interfacing the tail module with the remote element;
wherein interconnection of the intelligent device to the remote element is provided via the manager module and the tail module when the intelligent device is in communication with the manager module.

20. The method for interconnecting of claim 19, the method further comprising:
maintaining a connection to the remote element on behalf of the intelligent device via a proxy application in the tail module, in the event that the intelligent device is no longer in communication with the manager module.

21. The method for interconnecting of claim 19, the method further comprising:
maintaining a connection to the remote element on behalf of the intelligent device via a proxy application in the manager module, in the event that the intelligent device is no longer in communication with the manager module.

22. The method for interconnecting of claim 19, wherein the intelligent device is interconnected to the remote element without using an application in the intelligent device to interface the intelligent device to a communications protocol of the remote element.

23. The method for interconnecting of claim 19, wherein only a single tail module is utilized to effect interconnection of the intelligent device to the remote element.

24. The method for interconnecting of claim 19, wherein plural tail modules are utilized to effect interconnection of the intelligent device to the remote element.

25. The method for interconnecting of claim 19, wherein a first one of the at least one tail modules is utilized to effect interconnection of the intelligent device to the remote element, and wherein a second one of the at least one tail modules is utilized to effect interconnection of the intelligent device to a second remote element.

26. The method for interconnecting of claim 19, wherein the tail module is utilized to effect interconnection of the intelligent device to the remote element, as well as a second remote element.

27. The method for interconnecting of claim 19, wherein the remote element comprises a network.

28. The method for interconnecting of claim 19, wherein the manager module communicates with the intelligent device via a network.

29. The method for interconnecting of claim 28, wherein the manager module communicates with the intelligent device via a wired network.

30. The method for interconnecting of claim 19, wherein the remote element comprises a database.

31. The method for interconnecting of claim 19, wherein the remote element comprises a special application

32. The method for interconnecting of claim 19, the method further comprising:
establish a virtual local area network by configuring the manager module to include a list of users, a list of files, and privilege designation.

33. The method for interconnecting of claim 19, the method further comprising:
establish a virtual local area network by configuring the tail module to include a list of users, a list of files, and privilege designation.

34. The method for interconnecting of claim 19, the method further comprising:
connecting the tail to a notification interface so as to enable transmission of a notification from the tail to the intelligent device.

35. The method for interconnecting of claim 19, the method further comprising:
establishing a communication link between the tail module and another tail module.

36. A method for effecting electronic commerce via an intelligent device interconnected with a remote network, the method comprising:
causing the intelligent device to be in communication with a manager module adapted for communication with the intelligent device;
establishing interconnection of the intelligent device to the network via the manager module interfaced with a tail module according to an application program interface, the tail module being interfaced with the network;
establishing communication between the intelligent device and a server connected to the network; and
identifying an item on the server using the intelligent device in communication with the server via the interconnection of the intelligent device to the network provided via the manager module and the tail module.

37. The method for effecting electronic commerce of claim 36, further comprising:
requesting fulfillment of the item to a destination via the network in exchange for consideration.
